(19) United States
(12) Patent Application Publication
(10) Pub. No.: US 2009/0002332 A1
(43) Pub. Date: Jan. 1, 2009

(54) METHOD AND APPARATUS FOR INPUT IN TERMINAL HAVING TOUCH SCREEN

(76) Inventors: Sung-Soo Park, Suwon-si (KR); Dong-Kyoon Han, Seongnam-si (KR); Yu-Sheop Lee, Suwon-si (KR)

Correspondence Address: CHA & REITER, LLC, 210 ROUTE 4 EAST STE 103, PARAMUS, NJ, 07652, US

(21) Appl. No.: 12/131,372

(22) Filed: Jun. 2, 2008

(30) Foreign Application Priority Data
Jun. 26, 2007 (KR) 62942/2007

(51) Int. Cl. G06F 3/041

(52) U.S. Cl. 345/173

(57) ABSTRACT

A method and an apparatus for detecting input to a terminal having a touch screen. The method includes the steps of: displaying an active cell activating any one of a plurality of objects displayed on a screen; sensing a touch on a display screen; checking a position touched and a shift direction and a shift distance touched on a basis of the position touched by the user's finger; shifting a position of the active cell according to the shift direction and the shift distance touched; and performing an action of a corresponding object of an area of the active cell if a double tapping signal input on the display screen is sensed.

### CLAIM OF PRIORITY

This application claims the benefit under 35 U.S.C. §119(a) from an application entitled “Method and Apparatus for Input in Terminal Having Touch Screen,” filed in the Korean Intellectual Property Office on Jun. 26, 2007 and assigned Serial No. 2007-0062942, the content of which are hereby incorporated by reference in its entirety.

### BACKGROUND OF THE INVENTION

1. Field of the Invention

The present invention relates to a touch input method in a mobile communication terminal. More particularly, the present invention relates to a method and an apparatus for input in a mobile communication terminal having a touch screen, in which a navigation key and a pointer of a screen manipulated for diverse functions on a limited screen are applied to an entire screen having an integrated function of a touch screen and a touch pad, so that the touch screen is suitable for a compact mobile communication terminal having various functions requiring detailed pointing.

2. Description of the Related Art

Initially, a mobile communication terminal was used for only voice communication. However, there has been an ever-increasing degree of functionality added to mobile communication terminals which now includes using mobile communication terminals used for playing games, for listening to DMB broadcasting, and downloading, as well as playing and listening to MP3 music as necessary, or the like.

As more complex functions for the mobile communication terminal have been released, the menu items that permit the user to select a desired function of the mobile communication terminal becomes more and more diverse. Therefore, in order to select a desired menu item from the large number of available items, a complicated series of processes is required to select a specific item, wherein a user may repeatedly operate one or more function keys prior to selecting the desired function.

As shown in FIG. 1, in an input method using a conventional navigation key 100 and a finger mouse 110, the navigation key 100 is provided for decreasing a series of repetitive manipulation of a function key, and not only indicates directions of left, right, up, and down, but also performs a role as a function key for a number of diverse functions. Further, the finger mouse (an optical joystick) 110 is generally positioned in the center of the navigation key 100, and a user puts his finger on the finger mouse (optical joystick) and by shifting his finger about, causes the display of cursor to shift position on the screen. In other words, the finger mouse has a built-in motion recognition sensor, and if the user moves his finger as he would move the mouse of a PC to manipulate position of the cursor, a built-in optical sensor recognizes the motion so as to display the cursor on the screen, and then the cursor is shifted according to the motion of the finger.

Moreover, in one particular example of the above, a Personal Digital Assistant (PDA) employs a touch pad, not only so that a user can provide input using a touch screen and a stylus pen, but also, so that when a user lightly presses the touch pad in a search mode, the PDA recognizes that a button has been pressed, and the user can shift a pointer of the mouse through the touch pad in a cursor mode.

However, as shown in FIG. 2, in a navigation key button method (or a pointer method) on the touch screen employing the above-described input method, the user directly touches and taps a key of a specific function using his finger in order to perform a desired action so as to shift a highlighted menu item or execute an action of a selected menu item. However, considering the trend of making the terminal compact with reduced weight, the size of the navigation key is decreased according to the limited space available for the key array, and thus the size of the touch screen for displaying every key of a keyboard on the screen is also decreased, so that an undesired instruction may be executed until the user becomes accustomed to manipulating the screen, thereby occurring the inconvenience of having to re-input.

Further, for example, if a size of the user's finger touching the touch screen is larger than a displayed icon, it is difficult to accurately point to the icon. Therefore, a malfunction of executing the undesired action frequently happens due to an inaccurate input error. Such malfunctions cause a significant level of dissatisfaction with the overall product.

### SUMMARY OF THE INVENTION

Accordingly, the present invention has been made in part to solve at least some of the above-mentioned problems occurring in the prior art, and to provide the advantages described herein below. The present invention provides a method and an apparatus for input in a mobile communication terminal having a touch screen, in which a navigation key and a pointer of a screen manipulated for diverse functions on a limited screen are applied to an entire screen having an integrated function of a touch screen and a touch pad, so that the touch screen is suitable for a compact mobile communication terminal having various functions requiring detailed pointing.

In accordance with an aspect of the present invention, there is provided a method for input in a terminal having a touch screen, the method including the steps of: displaying an active cell activating any one of a plurality of objects displayed on a screen; sensing a touch of a user's finger on a display screen; checking a position touched by the user's finger and a shift direction and a shift distance of the user's finger on a basis of the position touched by the user's finger; shifting a position of the active cell according to the shift direction and the shift distance of the user's finger; and performing an action of a corresponding object of an area of the active cell if a double tapping signal is input on the display screen from the user.

In accordance with another aspect of the present invention, there is provided an apparatus for touch input in a terminal having a touch screen, the apparatus including: a sensing unit sensing a touch of a user's finger on a display screen and a tapping signal input from the user, and discriminating a corresponding area of the sensed finger so as to output the corresponding area; a check unit outputting a shift direction and a shift distance of the user's finger; and a control unit receiving the tapping signal from the sensing unit and controlling a position of an active cell or a pointer activating an object displayed on the screen according to the shift direction and the shift distance of the user's finger checked from the check unit.

### BRIEF DESCRIPTION OF THE DRAWINGS

The above and other exemplary aspects, features and advantages of the present invention will become more apparent from the following detailed description taken in conjunction with the accompanying drawings, in which:

FIG. 1 is an exemplary view of a screen illustrating a method of pointer input using a conventional navigation key and a finger mouse;

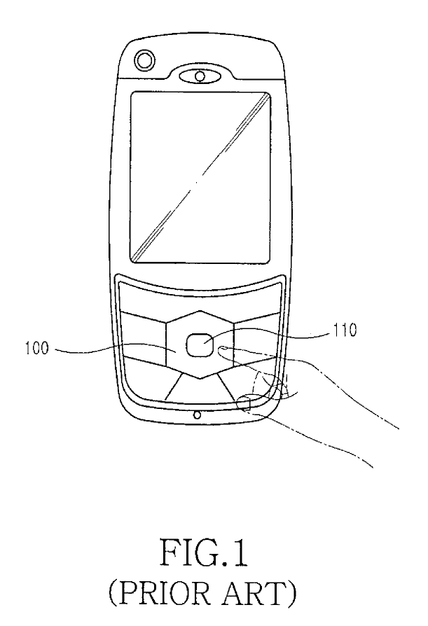

FIG. 2 is an exemplary view of a screen illustrating an input method using a conventional touch screen;

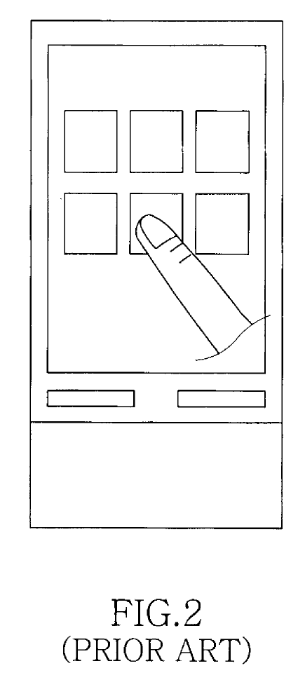

FIG. 3 is a block diagram illustrating an exemplary configuration of a mobile communication terminal according to the present invention;

FIG. 4 is an example of a screen for a touch input method using an active cell according to an embodiment of the present invention;

FIGS. 5A and 5B are examples illustrating a shift of an active cell based on a shift direction and a shift distance of a user's finger on a screen according to an exemplary embodiment of the present invention;

FIG. 6 is an example illustrating a shift of an active cell upon scrolling a screen according to an embodiment of the present invention;

FIG. 7 is an example illustrating a shift of an active cell upon using a touch screen according to an embodiment of the present invention;

FIGS. 8A, 8B, and 8C are examples illustrating a shift of a pointer on a screen based on the ratios upon screen scaling according to another embodiment of the present invention;

FIGS. 9A and 9B are examples illustrating a motion of a screen upon shifting the screen using a screen shift display bar according to another embodiment of the present invention; and

FIG. 10 is a flowchart illustrating a touch input method in a terminal having a touch screen according to another embodiment of the present invention.

### DETAILED DESCRIPTION

Hereinafter, embodiments of the present invention will be described with reference to the accompanying drawings. For the purposes of clarity and simplicity, a detailed description of known functions and configurations incorporated herein will be omitted when their inclusion may obscure appreciation by a person of ordinary skill in the art of the subject matter of the present invention.

A memory (not shown) applicable to the present invention includes but is not limited to examples such as a Read Only Memory (ROM), a Random Access Memory (RAM), a voice memory, or the like, for storing a plurality of programs and information necessary for implementing an action of the present invention. In the memory according to the present invention, software is programmed and stored in order to track the motion of a pointer by a user's finger or by other input apparatus on a touch screen. It should also be understood and appreciated by a person of ordinary skill in the art that while the term “finger” is used to describe touch, and is preferred, the touching, tapping and other movement on and along of the screen can be effectuated by a stylus or other type of instrument.

Hereinafter, it is noted that the present invention provides a method and an apparatus for using a function of a touch screen and a touch pad through combining the functions in an entire screen of a terminal.

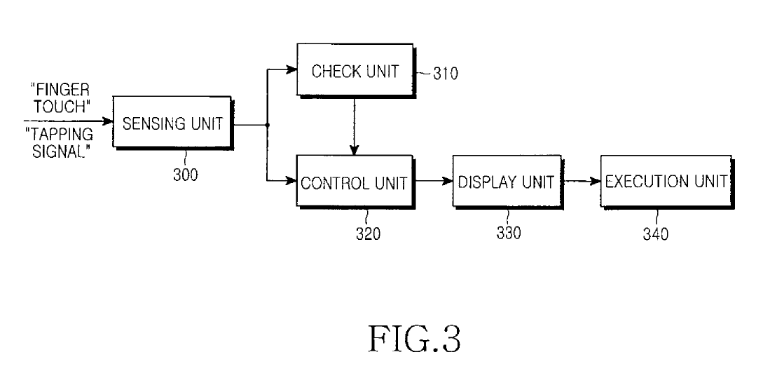

FIG. 3 is a block diagram illustrating a configuration of a mobile communication terminal of the present invention. Hereinafter, the use of the word terminal includes any terminal having a display device, a few of the many examples of which include a cellular phone, a personal portable communication cellular phone, a complex wireless terminal, an Automatic Teller Machine (ATM), etc., and will be described on the assumption that the terminal has a general configuration.

Referring to the example shown in FIG. 3, a touch input apparatus employed in the terminal having a touch screen according to this particular example of the present invention can include a sensing unit 300, a check unit 310, a control unit 320, a display unit 330, and an execution unit 340.

First, the sensing unit 300 senses the touch of the user's finger on a display screen and a tapping signal from the user, and discriminates and outputs a corresponding area of the sensed finger. Here, the corresponding area refers to the area in which the user's finger is recognized, and the pointer on the screen is shifted using coordinates, by which a touch pad area in which the finger can be shifted to the desired position, which is also a display area.

The check unit 310 outputs a shift direction and a shift distance of the user's finger on the touch pad area.

More specifically, the check unit 310 checks a current reference position of the user's finger sensed from the sensing unit 330 sensing the touch of the user's finger, and outputs information on an input proceeding direction according to the shift of the user's finger on a basis of the checked position of the finger. For example, the check unit 310 checks a value of the position of the current user's finger, and outputs the shift direction and a value of the shifted position from the value of the checked position.

Still referring to FIG. 3, the control unit 320 controls a general action of the mobile communication terminal employing the present invention. The control unit 320 receives the shift direction and the shift distance from the position currently touched by the user's finger from the check unit 310 and controls a basic active cell or the pointer currently displayed on the screen. Here, the active cell or the pointer is an indication that any one of the objects displayed on the screen has been selected. For example, the active cell may provide an indication by, for example, highlighting the object, and the pointer may be indicated as, for example, a predetermined arrow, and both are simultaneously controlled together with the shift of the user's finger. Also, the object may include any one of, for example, a character, an icon, a scroller, a check box, and a slider.

Further, the control unit 320 receives from the sensing unit 300 a tapping signal of the user's finger as sensed by the sensing unit 300. Here, the tapping signal typically refers to a command signal for executing an action of the corresponding object selected by the user, and an action corresponding to the one time tapping signal and the two times tapping signal is discriminated, respectively, so as to execute the command. It should be understood that the present invention is not limited to a receipt of a tapping signal one time or two times, as this example is provided for illustrative purposes.

More particularly, if the control unit 320 receives the tapping signal of the user's finger sensed from the sensing unit 300 one time (indicating, for example, one tap), the object corresponding to the value of the position where the tapping signal of one time is input is selected and activated by means of the active cell or the pointer, and the control unit 320 waits until when another command signal, i.e., the tapping signal or the finger motion, is input from the user.

Further, if the control unit 320 receives the tapping signal of the user's finger sensed from the sensing unit 300 two times (indicating, for example, two taps), the control unit 320 executes an action of the corresponding object selected by the active cell or the pointer displayed on the current screen.

Furthermore, according to one exemplary aspect of the present invention, if the control unit 320 receives information on a currently displayed screen but cannot display all the currently supplied information on the screen, it controls a screen shift display to be displayed on the current screen for informing the fact that an additional screen for further information remains to be displayed in addition to the information displayed on the current screen.

For example, the display unit 330 displays the shift of the active cell or the pointer according to the control of the control unit 320. Further, the display unit 330 displays the screen shift display indicating the fact that the screen area currently displayed through the control of the control unit 320 is a partial area of the entire screen area.

The execution unit 340 performs a corresponding action of the object currently selected from the control unit 320.

In the meantime, the tapping signal sensed from the sensing unit determines the tapping signal of the user's finger sensed from the area of the object to a predetermined area for indicating the tapping signal of the corresponding object. Therefore, if the touched area is the corresponding area of the object and is included in the predetermined area, the action corresponding to the object can be executed, even though the user touches an area slightly off from the corresponding area of the object.

Hereinafter, the touch input method in the terminal having the touch screen according to an exemplary embodiment of the present invention will be described through explaining an exemplary operation with reference to the above-described components of the present invention.

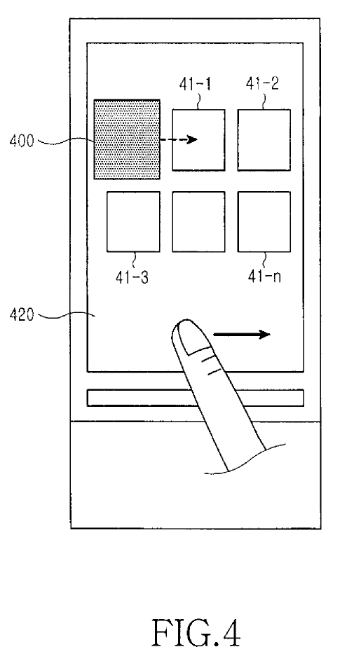

FIG. 4 is an example of one way a screen used for a touch input method using the active cell according to an exemplary embodiment of the present invention may look. The illustration provided in FIG. 4 is provided for explanatory purposes, and the claimed invention is not limited to the example shown.

Referring to FIG. 4, an exemplary display screen employed in the present invention, i.e., a touch pad 420 area, which is integrated with an area for displaying a plurality of objects, simultaneously performs a role of the display unit for displaying screen information and a role of the sensing unit for sensing the user's finger and executing the action of the selected object.

First, when any one of the plurality of objects 41-1, 41-2, 41-3 . . . , and 41-n, displayed on the touch pad 420 area, is activated by a basic active cell 400, the sensing unit 300 senses the user's finger on the touch pad 420 area, and the check unit 310 recognizes a sliding direction of the user's finger and the amount of the shift distance, so as to shift the position of the active cell 400. At this time, the active cell 400 is basically provided until a predetermined signal is input from the user. Therefore, the position of the active cell 400 is shifted based on the motion and the shift distance of the user's finger positioned on the touch pad 420 area.

Next, the check unit 310 calculates the value of the position of the active cell 400 based on the motion and the shift distance of the user's finger. Therefore, even though the screen is diminished for displaying many objects, the user can select the desired object while seeing the shift of the active cell so that mal-function may be decreased.

In the meantime, an area except for the display screen having the touch pad 420 area of the present invention, not shown in FIG. 4, can include a plurality of number keys, which means a general keypad, and the user can input a number or a character by using the keypad.

Further, if the user presses a predetermined execution button implemented on the keypad instead of touching the keypad, the action of the corresponding object of the active cell displayed on the screen can also be performed.

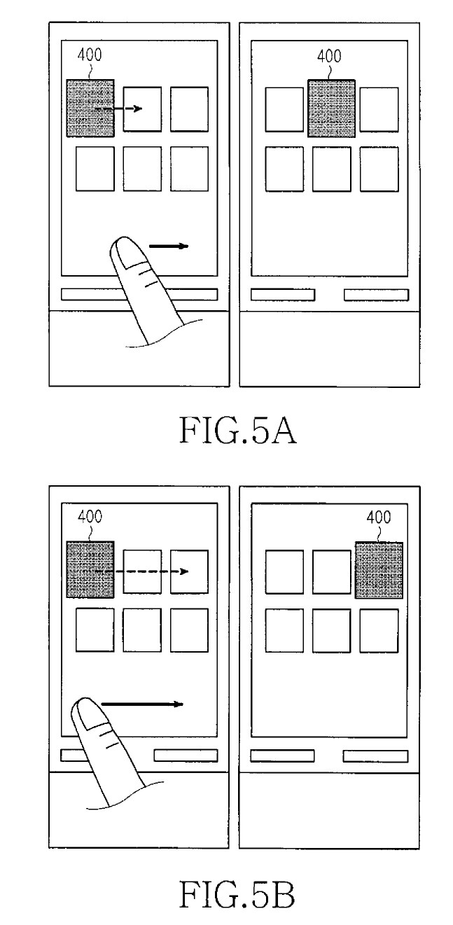

FIGS. 5A and 5B are exemplary views of a screen displaying a shift of the active cell 400 based on the shift direction and the shift distance of the user's finger according to an exemplary embodiment of the present invention. Referring to the example in FIG. 5A, if the user shortly slides the finger on the screen in a state of the basic active cell 400 being displayed, the amount of the shift of the active cell is controlled proportional to a sliding distance, which could be relatively short or relatively long. Referring to FIG. 5B, if the user long slides the finger on the screen in a state of the basic active cell being provided, the amount of the shift of the active cell, which is controlled proportional to the sliding distance, is relatively long. This relatively long distance may be referred to as “long-controlled”, and the relatively short sliding distance shown in FIG. 5A may be referred to as “short-controlled”. In any event, the shift of the active cell is proportional to the sliding distance of the user's finger.

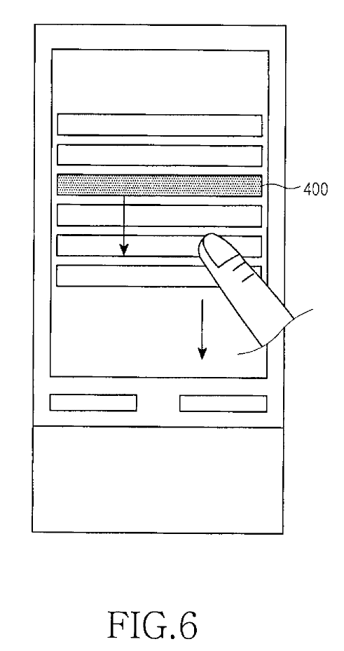

FIG. 6 is an exemplary view of a screen displaying a screen scroll action using the active cell according to an exemplary embodiment of the present invention. As shown in FIG. 6, upon scrolling the screen using the active cell, by sliding the user's finger in a downward direction until the desired object is displayed, the user can use the screen while seeing the basically provided active cell, even though a plurality of objects cannot be displayed on the screen.

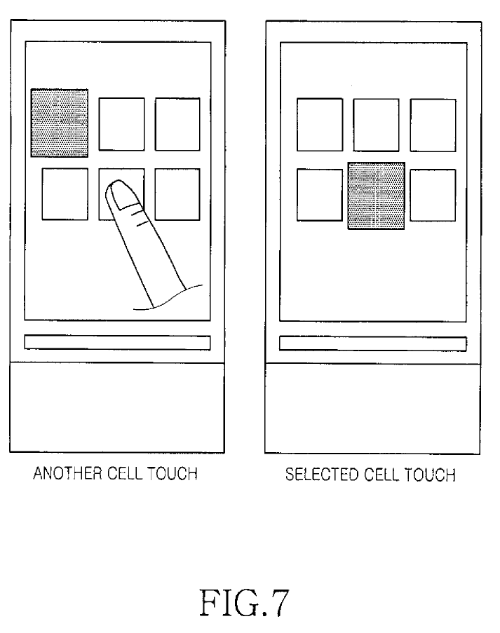

FIG. 7 is an exemplary view of a screen displaying a shift of the active cell according to an exemplary embodiment of the present invention. As shown in FIG. 7, if the user directly touches the desired object on the touch pad 420 area on which the plurality of objects are displayed, the currently displayed active cell is shifted from the area of the object of the current active cell to the area of the corresponding object in which the tapping signal of the user's finger is input. The sensing unit 300 receives the tapping signal of the touched user's finger and provides an output to the control unit 320 that the tapping signal has been received. Subsequently, the control unit 320 controls the position of the basic active cell to be shifted according to the value of the position currently touched by the user's finger through the display unit 330.

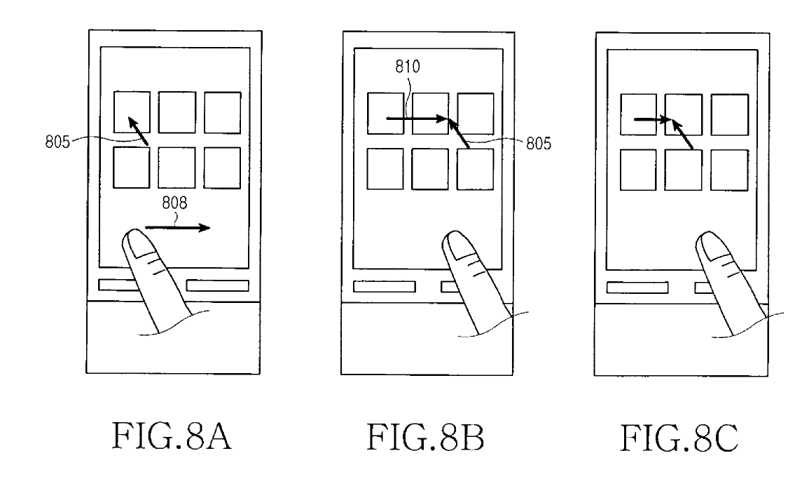

FIGS. 8A, 8B, and 8C are exemplary views of a screen displaying a touch input method using a pointer through screen scaling according to another exemplary embodiment of the present invention. FIGS. 8A, 8B, and 8C show that the desired object is selected, i.e. pointed, by means of a basic pointer displayed on the display screen, so that the action of the corresponding object is performed. More particularly, in this example, an operation wherein the ratio of the shift distance of the user's finger to the shift distance of the pointer according to the screen scaling is shown.

The display of the pointer 805 (shown in FIG. 8A) is controlled to point to the desired object in a shift direction and a shift distance (identified by arrow 808) of the touched user's finger in a proportion (identified by arrow 810) shown in FIG. 8B. The proportion can be longer, shorter or equal than the actual shifted distance of the user's finger. Here, the pointer 805, which is shown in the examples in FIGS. 8A-8C includes a shape of an arrow of a predetermined direction. However, the present invention is not limited thereto, and a pointer having diverse shapes may be provided in order to satisfy the user's desire.

Moreover, the screen scaling permits an interval of coordinates itself of the screen touched by the user's finger is enlarged or diminished up to a predetermined size, which is for more accurately pointing the object through shifting the pointer corresponding to the shift of the user's finger.

For example, FIG. 8A illustrates the shift of the pointer 805 in a standard screen before the screen scaling control, wherein the pointer is shifted in the shift direction of the user's finger proportional to the shift of the user's finger. FIG. 8B illustrates the shift of the pointer according to the shift of the user's finger on a standard screen scaled at a ratio of 1:1, which is the ratio of the shift distance of the user's finger with respect to the shift distance of the pointer. In the screen scaled at a ratio of 1:1 shown in FIG. 8B, the shift distance of the user's finger is identical to the shift distance of the pointer 805 of the standard screen of FIG. 8A.

FIG. 8C illustrates the shift of the pointer 805 according to the shift of the user's finger on a standard screen scaled at a ratio of 2:1, which is the ratio of the shift distance of the user's finger with respect to the shift distance of the pointer. Referring to the standard screen shown in FIG. 8A, the shift distance of the user's finger is identical, while the shift distance of the pointer is short. Therefore, in the scaled screen, the pointer is shifted at a ratio of 2:1 corresponding to the shift of the user's finger.

As shown in FIGS. 8A, 8B, and 8C, the method of the screen scaling is not limited to use of the pointer, but may be applicable in using the active cell.

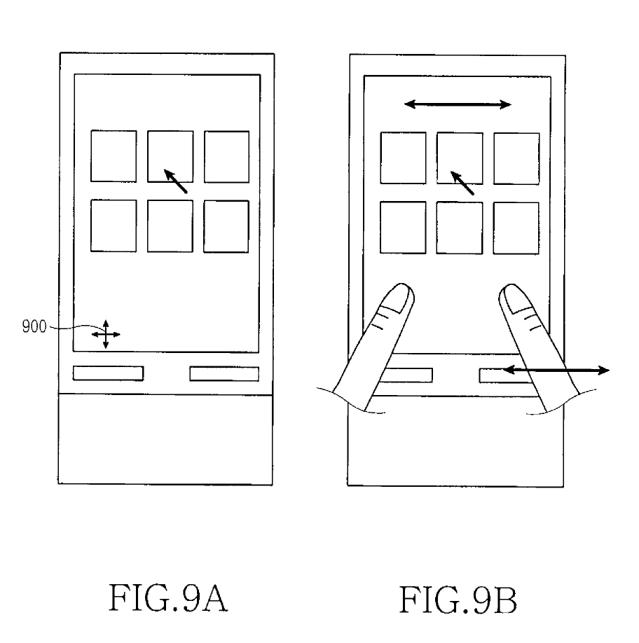

FIGS. 9A and 9B are exemplary views of a screen displaying a shift of the screen upon using a screen shift display bar according to an exemplary embodiment of the present invention. Referring to FIG. 9, if the control unit 320 receives information on the currently displayed screen but cannot display all currently supplied information on the screen, the screen shift displays information alerting the user to the fact that an additional screen display of more information remains to be displayed in addition to the information displayed on the current screen; this information alerting the user is displayed on the current screen through the screen shift display bar 900. The screen shift display bar 900 is employed in a case where several screens, such as a map, a web site, and in document work, are supplied so as to require the shift of the screen. The entire area of the current screen cannot be displayed on the small screen of the mobile communication terminal of the present invention, so that the entire area of the screen can be provided by means of the screen shift display bar 900. At this time, if the touch of the user's finger is sensed on the screen shift display bar 900, and another touch of the user's finger is sensed in a predetermined area, a page of the screen, i.e., as a screen unit, not the active cell or the pointer displayed on the current screen, is shifted.

In the meantime, if the user presses the predetermined execution button for executing the screen shift display bar implemented on the keypad instead of the touch action of the user's finger, the action of the screen shift display bar displayed on the screen can be performed. That is, if the user presses the predetermined execution button for executing the screen shift display bar one time instead of touching the screen shift display bar displayed on the current screen, the press action of one time is determined to be identical to the touch action of the user's finger on the screen shift display bar. Therefore, the user presses the predetermined execution button one time, and at the same time can shift the screen according to the shift direction and the shift distance of the user's finger on the screen.

Further, if the user presses the predetermined execution button two times for executing the screen shift display bar, an action of recognizing the screen shift display bar displayed on the screen is returned.

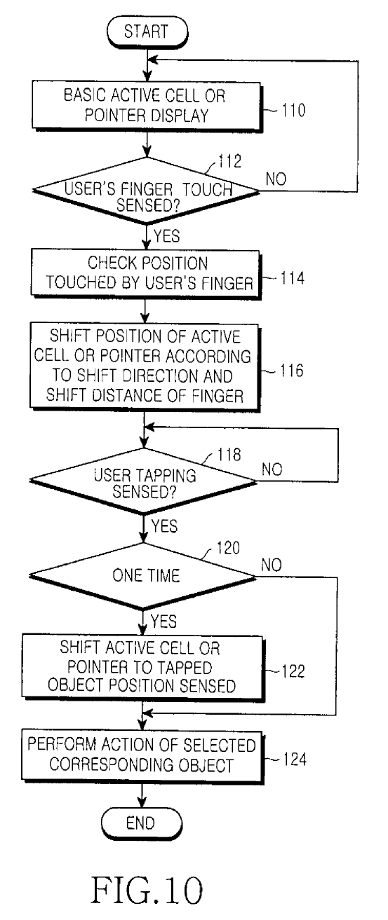

As described above, the present invention is provided for more accurately selecting the desired object by using the active cell or the pointer on the screen having the integrated function of the touch screen and the touch pad. Hereinafter, the touch input method in the terminal having the touch screen according to an exemplary embodiment of the present invention will be described with reference to the flowchart of FIG. 10. A person of ordinary skill in the art understands and appreciates that the method is not limited to the steps as shown in the flowchart.

Referring to the exemplary flowchart shown in FIG. 10, in the mobile communication terminal according to the present invention, the basic active cell or the pointer is displayed on the display screen in a standby state before the predetermined command signal is input from the user S110. At this time, the position of the basic active cell or the pointer can be either an area of one object or an area exclusive of the one object. Also, if the touch of the user's finger is sensed on the display screen S112, the position touched by the user's finger on the current screen is checked S114.

After checking the position of the user's finger, the position of the active cell or the pointer is simultaneously shifted according to the sliding direction (i.e. slid direction) sensed and the shift distance of the current finger from the position value on a basis of the value of the position touched by the sensed finger S116.

When one object is selected by the active cell or the pointer through the above steps, it is determined whether the tapping signal (input from the user S118 is sensed. If the tapping signal is sensed as being received one time S120, the position of the active cell or the pointer is shifted to the tapped object on the touch screen area S122.

Further, if the tapping signal is sensed as being received more one time, the action of the corresponding object selected by the active cell or the pointer is performed S124.

As described above, the input method, the configuration of the apparatus, and its action in the mobile communication terminal having the touch screen can be implemented according to the exemplary embodiment of the present invention. While the invention has been shown and described with reference to certain exemplary embodiments thereof, it will be understood by those skilled in the art that various changes in form and details may be made therein without departing from the spirit of the invention and the scope of the appended claims.

What is claimed is:

1. A method for input in a terminal having a touch screen, the method comprising:
displaying an active cell for activating any one of a plurality of objects displayed on a screen;
sensing a touch on a display screen;
checking a position touched on the display screen and a shift direction and a shift distance of the sensed touch on a basis of the position of the display screen sensed as being touched;
shifting a position of the active cell according to the shift direction and the shift distance of the sensed touch; and
performing an action of a corresponding object of an area of the active cell if a double tapping signal applied to the display screen is sensed.

2. The method as claimed in claim 1, further comprising:
displaying a screen shift bar at a predetermined position of the display screen if information on a currently displayed screen area is received and the screen area is equal to or more than a threshold;
sensing the touch on the displayed screen shift bar; and
checking the touch on an area except for an area of the screen shift bar if the touch is sensed on the screen shift bar, and shifting the currently displayed screen according to the shift direction and the shift distance of the sensed touch.

3. The method as claimed in claim 2, wherein an action of the screen shift bar is implemented by actuation of a predetermined key button.

4. The method as claimed in claim 3, wherein, if the predetermined key button is sensed as being actuated one time, the acutation corresponding to a touch action on the screen shift bar.

5. The method as claimed in claim 3, wherein, if the predetermined key button is sensed as being actuated two times, the screen shift bar displayed on the screen is activated.

6. The method as claimed in claim 1, further comprising performing an action of a corresponding object of an area of the active cell if an action signal of actuating a predetermined execution button is sensed.

7. The method as claimed in claim 1, further comprising shifting a position of the active cell to an area of the corresponding object on which the sensed touch is currently positioned if a tapping signal is sensed one time on the display screen.

8. The method as claimed in claim 7, wherein an area for displaying the corresponding object to a predetermined area is recognized as an area for sensing the taping signal.

9. The method as claimed in claim 1, wherein the shift of the active cell is displayed according to the shift direction and the shift distance of the sensed touch.

10. The method as claimed in claim 1, wherein the object includes any one of a number, a character, an icon, a scroller, a check box, and a slider.

11. The method as claimed in claim 1, wherein the object is displayed on the screen and is activated by touch.

12. The method as claimed in claim 1, wherein the active cell can be implemented by means of a pointer pointing to the object.

13. The method as claimed in claim 12, wherein the pointer is displayed as an arrow of a predetermined direction.

14. An apparatus for touch input in a terminal having a touch screen, the apparatus comprising:
a sensing unit sensing a touch on a display screen and a tapping signal applied to the display screen, and for discriminating a corresponding area of the sensed touch so as to output the corresponding area;
a check unit outputting a shift direction and a shift distance of the sensed touch on the display screen; and
a control unit receiving an output from the sensing unit that a tapping signal has been sensed by the sensing unit and for controlling a position of an active cell or a pointer activating an object displayed on the display screen according to the shift direction and the shift distance of the sensed touch checked from the check unit.

15. The apparatus as claimed in claim 14, wherein the control unit controls the position of the active cell or the pointer to be a position of the corresponding object selected by the sensed touch on the display screen if the corresponding area of the sensed touch on the display screen is included in an area for displaying a plurality of objects.

16. The apparatus as claimed in claim 14, wherein the control unit controls a screen shift bar displayed on a predetermined position of the display screen when the control unit receives information on a currently displayed screen and determines that an area of all screen is equal or more than a threshold.

17. The apparatus as claimed in claim 14, further comprising an execution unit for performing an action of the corresponding object activated by means of the active cell or the pointer if a control signal is input from the control unit.

18. The apparatus as claimed in claim 14, wherein the object includes any one of a number, a character, an icon, a scroller, a check box, and a slider.

19. The apparatus as claimed in claim 14, wherein the object is displayed on the screen for selection.

20. The apparatus as claimed in claim 14, wherein the pointer is displayed as an arrow of a predetermined direction.
